(19) United States
(12) Patent Application Publication
(10) Pub. No.: US 2026/0261201 A1
(43) Pub. Date: Sep. 3, 2026

(54) METHOD FOR PROVIDING SINUSOIDAL PHASE CURRENTS WITH CONTROLLING AND CHARGING

(71) Applicant: ACD Antriebstechnik GmbH, Achstetten (DE)

(72) Inventor: Aaron Fesseler, Achstetten (DE)

(21) Appl. No.: 18/718,182

(22) PCT Filed: Dec. 13, 2022
(86) PCT No.: PCT/EP2022/085671

§ 371 Date: Jun. 10, 2024

(30) Foreign Application Priority Data
Dec. 13, 2021 (LU) LU501001

(51) Int. Cl. H02M 1/42; H02M 7/217

(52) U.S. Cl. CPC H02M 1/4216; H02M 1/4225; H02M 7/217

(57) ABSTRACT

A method and the use of the method for providing sinusoidal phase currents from a three-phase supply network to a rectifier, the method comprising the steps of detecting and evaluating string voltages, rectifying the string voltages, connecting a capacitor to a positive output or negative output of a rectifier via one of a first switching transistor or a second switching transistor, controlling control inputs of the first switching transistor and the second switching transistor by the control unit such that only the first switching transistor, only the second switching transistor, both or neither of the first and second switching transistors become(s) conductive, and charging a capacitor voltage to a capacitor depending on controlling the control inputs such that differences between the string voltages and the capacitor voltage, which drops across coils, lead to sinusoidal flows of the mean values of the coil currents.

### CROSS REFERENCE TO RELATED APPLICATIONS

This application claims priority to Luxembourg patent application LU501001, filed on Dec. 13, 2021, the entire contents of the Luxembourg patent application LU501001 are hereby incorporated by reference herein in their entirety.

### FIELD OF THE INVENTION

The present invention relates to a method for modulating or clocking string voltages of a network circuit from a three-phase supply network. The method ensures that phase currents at the input of a rectifier are essentially sinusoidal, irrespective of the load.

### BACKGROUND TO THE INVENTION

Network circuits are known from the prior art. EP 3 068 024 A1 discloses a three-phase pulse rectifier system with comparatively low reverse voltage stress on the power semiconductors that can be disconnected and high-power density, as well as low system perturbations. Such a three-phase three-point pulse rectifier, also known as a Vienna rectifier, is known to be characterized by a significantly lower harmonic component on the AC voltage side in contrast to conventional six-pulse bridge circuits used for rectifying three-phase current.

The Vienna rectifier is a circuit that requires a large number of components, which makes it very expensive and also requires a very complex controlling. The lossy components also have a negative effect on the efficiency of the Vienna rectifier.

FIG. 1 shows a known network circuit of a three-phase DCM step-up converter or a step-up converter according to the prior art. The network voltages present at the input on phases L1, L2, L3 are rectified and stepped up to a value greater than a network voltage value. There are numerous variations of this circuit, all of which have a similar architecture.

In the prior art, switching on a switching transistor T short-circuits a diode rectifier DGR. As a result, all three coils LL1, LL2, LL3 are charged in parallel, depending on the string voltages u1, u2, u3 present at this time. When the switching transistor T is switched off, the coils LL1, LL2, LL3 are discharged. The current increases or current slopes in the coils LL1, LL2, LL3 are proportional to the voltage values at the coils LL1, LL2, LL3 over a sinusoidal period when the switching transistor T is switched on. This means that the voltage drop across the coils LL1, LL2, LL3 and thus also the slope of the coil currents and their final value changes during a period of the network sine wave in the known network circuits. Physically, this does not lead to a “clean” sinusoidal flow of the network current iNL, as shown in FIGS. 2A and 2B. In particular, as can be seen in FIG. 2B, the phase current iNL1 has a dip in the range around 30° of a zero crossing N towards a saddle L and sinusoidal crests K towards the saddle L depending on the string voltages u1, u2, u3 applied at the input. In addition, a depth of the saddle K depends on a voltage difference between input-side string voltages u1, u2, u3 and output-side intermediate circuit direct voltage UZK. The higher the intermediate circuit direct voltage UZK on the output side or the smaller the load on the output, the smaller the dip in the area of the sine crests K. The same also applies to the phase currents iNL2, iNL3.

FIG. 3 shows another known three-phase DCM boost converter with two switching transistors T+, T− according to the prior art. Due to a connection to a neutral point N, a first diode D+ and a second diode D− are required in this known circuit. This circuit is suitable for describing both conventional and hitherto common control systems, which correspond to the basic principle of pulse width modulation, of the two switching transistors T+, T−.

On the one hand, both switching transistors T+, T− are switched on in a staggered manner within a period duration with staggered control (push-pull). Accordingly, the first switching transistor T+ conducts when the second switching transistor T− does not conduct, and vice versa. Depending on the duty factor or duty cycle of up to 50%, both switching transistors are temporarily non-conductive. The duty cycle is the ratio of the switch-on duration to the period of a pulse width modulation signal. With a duty cycle of over 50%, both switching transistors are temporarily conductive. Systems with such duty cycles function as two standard step-up converters working complementarily in push-pull. With this known type of clocking, the connection between a midpoint MP and the neutral point N as well as the first diode D+ in the positive branch and the second diode D− in the negative branch are absolutely necessary.

On the other hand, with synchronous/parallel control, both switching transistors T+, T− are switched on simultaneously within a period duration. Accordingly, the first switching transistor T+ and the second switching transistor T− are conductive or non-conductive at the same time. The switch-on duration of both switching transistors T+, T− is essentially dependent on the duty cycle. Systems with these known clockings function as two complementary standard step-up converters operating in common mode. With such known network circuits, it is possible to use only one switching transistor for both step-up converters (see FIG. 1). The connection between midpoint MP and neutral point N as well as one of the two diodes D+, D− can be omitted.

Depending on the duty cycle of the switching transistors, the intermediate circuit direct voltage UZK at the output of the network circuit can be regulated in its level. It is not possible to draw optimum sinusoidal currents from the network with these known clockings (see FIG. 2A, 2B).

It is also known that many loads connected to the public supply network draw pulsed network currents through simple bridge rectifiers, which are associated with large harmonic currents. These pulsed currents require the public supply network to be oversized. In addition, there are short-term voltage dips and voltage peaks, which increasingly lead to problems with sensitive loads. For this reason, there are corresponding (PFC) standards (see, for example, DIN EN 61000-3-2 and DIN EN 61000-3-12), which require the use of power factor correction (PFC) above a certain power. The use of active circuit solutions becomes necessary because the components in passive systems require a larger installation space and supply currents with a shape that deviates from a sine wave, such as the Vienna rectifier.

With the known network circuits shown in FIG. 1 and FIG. 3, as shown in FIG. 2A and FIG. 2B, a sinusoidal current with harmonics is drawn from the network, but the limit values defined in the PFC standards can at best only be met for low power or power classes.

Furthermore, an electrical converter for converting between an at least three-phase alternating current signal and a direct current signal is known from document WO 2021/219761 A1. The converter comprises at least three phase connections, a first direct current connection and a second direct current connection, a first converter stage and a second converter stage.

American patent document U.S. Pat. No. 7,005,759 B2 discloses an integrated converter. The integrated converter includes an AC/DC converter electrically connected to a three-phase power supply to convert an alternating current into a first direct current to achieve the object of power factor correction.

European patent application EP 2 814 164 A2 discloses a power converter comprising a multiphase primary stage between a multiphase voltage source and a DC intermediate circuit, an input filter for the primary stage, a secondary stage between the DC intermediate circuit and a multiphase load, with an additional bridge path for a neutral point of the load, the input filter comprising an input filter star point connected to a midpoint of the DC intermediate circuit via a connection capacitance.

The purpose of the present application is to provide sinusoidal phase currents at the input of a rectifier which fulfill the limit values of the PFC standards in all power classes.

### SUMMARY OF THE INVENTION

This document describes a method for providing sinusoidal phase currents from a three-phase supply network to a rectifier. The method comprises the steps of detecting and evaluating string voltages, rectifying the string voltages, connecting a capacitor to a positive output or negative output of a rectifier via one of a first switching transistor or a second switching transistor, controlling control inputs of the first switching transistor and the second switching transistor by the control unit in such a way that only the first switching transistor, only the second switching transistor, both or neither of the first switching transistor nor the second switching transistor become conductive, and charging a capacitor voltage at a capacitor depending on controlling the control inputs such that differences between the string voltages and the capacitor voltage which drops across coils lead to sinusoidal flows of the mean values of the coil currents.

The controlling is one of a positive controlling or a negative controlling, wherein the positive controlling takes place in a positive time interval and the negative controlling takes place in a negative time interval. The positive time interval is one in which two of three string voltages are positive. The negative time interval is one in which two out of three string voltages are negative.

The controlling in a time interval takes place in such a way that two of three string voltages have the same polarity.

According to a first aspect, the controlling takes place in such a way that in the positive controlling the first switching transistor is/becomes conductive at a first time up to a third time for a switch-on duration, the second switching transistor is/becomes conductive at a second time up to a fourth time for a switch-on duration and during the second time up to the third time the first and second switching transistors are/become conductive for a short-circuit duration.

In accordance with the first aspect, the first switching transistor is the first to conduct when two out of three string voltages are positive. This allows the capacitor to be charged accordingly in order to draw sinusoidal phase currents from the supply network that meet the limits of the PFC standards in the corresponding power classes.

According to a second aspect, the controlling takes place in such a way that in the negative controlling the second switching transistor is/becomes conductive at a first time up to a third time for a switch-on duration, the first switching transistor is/becomes conductive at a second time up to a fourth time for a switch-on duration and the first and second switching transistors are/become conductive at the second time up to the third time for a short-circuit duration.

In accordance with the second aspect, the second switching transistor is the first to conduct when two of the three string voltages are negative. This allows the capacitor to be charged accordingly in order to draw sinusoidal phase currents from the supply network that meet the limits of the PFC standards in the corresponding power classes.

According to a third aspect, the controlling takes place in such away that the switch-on duration of the first and second switching transistors is the same.

In accordance with the third aspect, the equal switch-on duration of the two switching transistors promotes the sinusoidal flow of the phase currents.

According to a fourth aspect, the controlling is performed in such a way that the switch-on duration of the first and second switching transistors is modulated.

In accordance with the fourth aspect, different switch-on durations can also be realized during a switching period in order to adapt the controlling more flexibly to the detected values of the string voltages. This allows the capacitor to be charged accordingly in order to draw sinusoidal phase currents from the supply network.

According to a fifth aspect, the short-circuit duration during controlling results in a period of time in which the first switching transistor and the second switching transistor are conductive.

In accordance with the fifth aspect, the length of the short-circuit duration can be influenced by means of the control in order to charge the capacitor in such a way as to draw sinusoidal phase currents from the supply network.

According to a sixth aspect, the controlling of the control inputs of the first and second switching transistors is clocked at a clock frequency higher than a network frequency.

In accordance with the sixth aspect, it is ensured that harmonic currents resulting from the clock frequency do not influence the sinusoidal flow of the phase currents. Furthermore, in accordance with the sixth aspect, the size of components such as coils and capacitors and thus component costs can be reduced the higher the clock frequency is selected.

According to a seventh aspect, charging includes one of precharging, charging, recharging and discharging.

In accordance with the seventh aspect, the capacitor can be controlled depending on the detected string voltages in such a way as to draw sinusoidal phase currents from the supply network by precharging, charging, recharging or discharging.

According to an eighth aspect, the method further comprises the step of providing a reference potential for the capacitor in the midpoint network on a coupling circuit.

In accordance with the eighth aspect, an artificial neutral conductor of the coupling circuit provides a voltage reference for a capacitor voltage of the capacitor in the midpoint network.

According to a ninth aspect, the method further comprises the step of detecting output variables of at least one of an intermediate circuit direct voltage, an intermediate circuit current, a positive and negative rectifier voltage, a capacitor voltage with respect to the reference potential and the capacitor current.

In accordance with the ninth aspect, further variables can be detected in order to improve the control of the two switching transistors. This allows the capacitor to be charged accordingly in order to draw sinusoidal phase currents from the supply network.

The present document also describes a use of the method for at least one of a charging station, a power supply unit, an electric drive for machines and systems for energy conversion on the supply network. The method can thus be used for a variety of applications to provide sinusoidal phase currents that meet the limits of the PFC standards in the corresponding power classes.

### BRIEF DESCRIPTION OF THE DRAWINGS

The invention will now be explained in more detail with reference to drawings. They show:

FIG. 1 shows a prior art step-up converter;

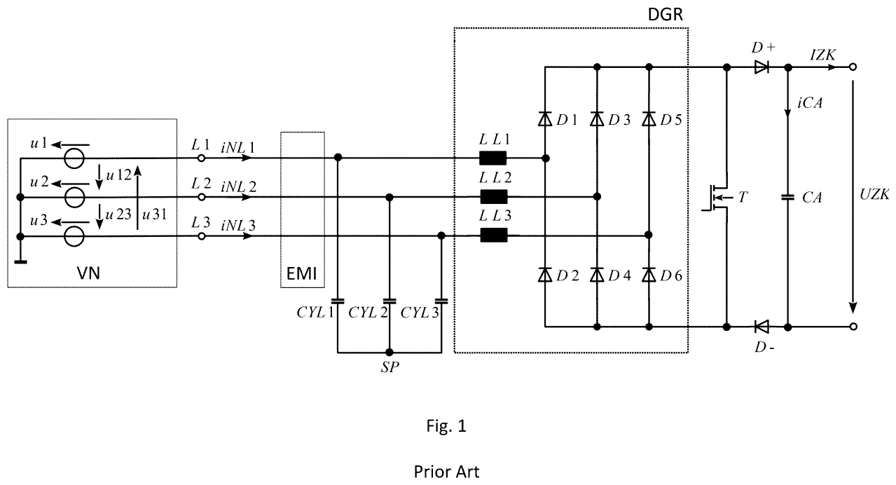

FIGS. 2A and 2B show current flows of the step-up converter from FIG. 1;

FIG. 3 shows a further prior art step-up converter;

FIG. 4 shows a network circuit according to a first embodiment;

FIG. 5 shows a flow of control signals in positive controlling;

FIG. 6 shows different characteristic curves in positive controlling;

FIG. 7 shows a flow of control signals in negative controlling;

FIG. 8 shows different characteristic curves in negative controlling;

FIG. 9 shows a flow of network voltages of a three-phase supply network with periodically alternating positive and negative controlling;

FIGS. 10A and 10B show current flows based on the positive and negative controlling in the network circuit according to FIG. 4;

FIG. 11 shows a flow diagram of a method according to the invention.

### DETAILED DESCRIPTION OF THE INVENTION

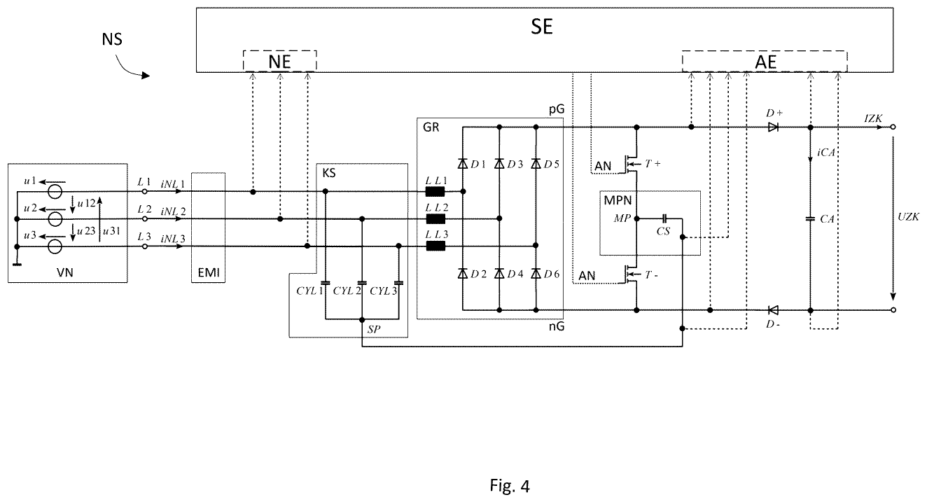

With reference to FIG. 4, a structure of a network circuit NS according to a first embodiment for providing an intermediate circuit direct voltage UZK and a load-dependent intermediate circuit current IZK at an output from a three-phase supply network VN is now described. The network circuit NS comprises at least one switching transistor T+, T− and a midpoint network MPN and is thus configured as a step-up converter. In particular, the network circuit NS is configured as a three-phase PFC step-up converter. The absolute value of an output voltage at the output of the network circuit NS is always greater than the absolute value of an input voltage of the network circuit NS. The absolute value of the intermediate circuit direct voltage UZK at the output is therefore greater than a rectified value of conductor voltages u12, u23, u31 at an input of the network circuit NS.

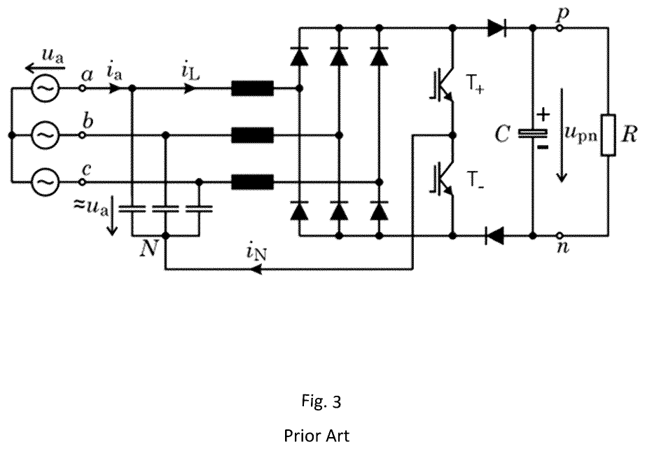

Compared to the circuit shown in FIG. 3, the network circuit NS is extended to a half bridge with the midpoint network MPN, comprising a capacitor CS. In addition, the network circuit NS has a connection to a neutral potential or reference potential SP.

An output capacitor CA of the network circuit NS is realized with a capacitor. In another example, the output capacitor CA can be realized as a series connection of two or more capacitors.

Preferably, the network circuit comprises a first switching transistor T+ and a second switching transistor T−. However, the network circuit NS is not limited to the first and second switching transistor T+, T−.

The network circuit NS also comprises further components which are connected to each other via phases or lines L1, L2, L3. The network circuit NS comprises an EMI filter or filter for electromagnetic interference EMI, a network detection NE, a control unit SE, a rectifier GR, a coupling circuit KS with the reference potential SP, a first diode D+ and a second diode D− on output lines of the network circuit NS and the output capacitor CA between the output lines.

At the input, the network circuit NS is connected to the supply network VN via phases L1, L2, L3. The phases L1, L2, L3 comprise network variables. The network variables comprise at least one of a phase position, network voltages comprising string voltages u1, u2, u3 and conductor voltages u12, u23, u31, and phase currents iNL1, iNL2, iNL3. The input of the network circuit NS connects the three-phase supply network VN to the EMI filter EMI via the phases L1, L2, L3. The EMI filter EMI filters electromagnetic interference in a known manner. For this reason and for the sake of brevity, the EMI filter EMI is not described in more detail here.

The network detection NE detects the network variables of phases L1, L2, L3, evaluates them and passes them on to the control unit SE. The network detection NE can be a separate unit or be included in the control unit SE. The control unit SE comprises an output detection AE in order to detect voltage and current variables at different positions, but in particular at the output of the network circuit NS. The output detection AE thus detects output variables, comprising at least one of the intermediate circuit direct voltage UZK and the intermediate circuit current IZK and also a positive and negative rectifier voltage uGR+, uGR−, the capacitor voltage uCS with respect to the reference potential SP and a capacitor current iCS at the capacitor CS. The network detection NE and the output detection AE can comprise different options for detecting the network variables and output variables. For example, the network variables can be detected by the network detection NE and the output detection AE by means of one or more sensors. However, the network variables can also be detected by the network detection NE and the output detection AE by means of a predetermined detection method, which is based on an ACTUAL/TARGET comparison.

The control unit SE uses the information about the voltage and current variables or network variables obtained from the network detection NE and the output detection AE in order to control the first and second switching transistors T+, T− in such a way as to provide a capacitor voltage uCS to the capacitor CS. The capacitor voltage uCS represents a voltage difference resulting from the difference between string voltages u1, u2, u3 and coil voltages uLL1, uLL2, uLL3, which drop across coils LL1, LL2, LL3. The controlling leads to sinusoidal flows of mean values of coil currents iLL1, iLL2, iLL3, as described in more detail below.

The control unit SE comprises a microprocessor or microcontroller or functionally similar components for evaluating the network variables detected by the network detection NE and output detection AE. The control unit SE is a known control unit according to the prior art. For this reason and for the sake of brevity, the control unit SE is not described in more detail herein.

The rectifier GR is constructed with rectifier diodes D1, D2, D3, D4, D5, D6 and with inductors or coils LL1, LL2, LL3 as energy storage. However, the rectifier GR is not limited to this embodiment example. The rectifier GR can be configured with passive components, active components and/or a combination thereof. The rectifier GR can therefore be a rectifier and inverter, which enables feedback into the supply network VN. The function of the rectifier GR corresponds to a known function and is therefore not described in more detail for the sake of brevity.

The coupling circuit KS is arranged between the midpoint network MPN and the rectifier GR. The coupling circuit KS is a capacitor star circuit comprising capacitors CYL1, CYL2, CYL3 and the reference potential SP. The reference potential SP is connected to the phases L1, L2, L3 via the capacitors CYL1, CYL2, CYL3. The coupling circuit KS is configured to create an artificial neutral conductor (neutral potential) in order to provide a voltage reference for the midpoint network MPN and thus for the capacitor CS. The midpoint network MPN (with the capacitor CS) is connected to the phases L1, L2, L3 via the reference potential SP of the coupling circuit KS.

The first switching transistor T+ and the second switching transistor T− each comprise a control input AN and a body diode (not shown) or a freewheeling diode connected in parallel with the switching transistors T+, T− (not shown). The control input AN of the first switching transistor T+ is connected to the control unit SE. The control input AN of the second switching transistor T− is connected to the control unit SE. The control unit SE controls the first switching transistor T+ and the second switching transistor T−, as described in more detail later.

The coupling circuit KS ensures that the higher-frequency currents caused by the controlling of the first and second switching transistors T+, T− are not visible in the phase currents iNL1, iNL2, iNL3.

The midpoint network MPN of the network circuit NS serves in its basic function as an adjustable voltage source and includes the capacitor CS. The capacitor CS of the midpoint network MPN is connected between a midpoint MP and the reference potential SP of the coupling circuit with the phases L1, L2, L3 at the input. The midpoint MP is provided between the first switching transistor T+ and second switching transistor T− connected in series. The capacitor CS is electrically connected to the rectifier GR via the first switching transistor T+ with a positive output pG of the rectifier GR and via the second switching transistor T− with a negative output nG of the rectifier GR.

The first diode D+ and the second diode D− are arranged at the output of the network circuit NS so that the intermediate circuit direct voltage UZK at the output remains independent of the clocking of the first and second switching transistors T+, T−. For clocking independence, either only the first diode D+, the second diode D− or both diodes D+, D− can be provided.

The capacitor CS of the midpoint network MPN is charged by a special type of controlling of the control input AN of the at least one of the first switching transistor T+ and the second switching transistor T− by the control unit SE. The charging of the capacitor CS corresponds to at least one of precharging, charging, recharging and discharging. The type of charging of the capacitor CS depends on the network variables detected by the network detection NE and the output detection AE.

The capacitor voltage uCS at the capacitor CS modulates the coil voltages uLL1, uLL2, uLL3 in such a way that sinusoidal phase currents iNL1, iNL2, iNL3 are drawn from the phases L1, L2, L3 of the supply network VN. The level of the capacitor voltage uCS depends on a duty cycle TV, as described below. As a result of the modulation, the phase currents iNL1, iNL2, iNL3 become essentially sinusoidal currents or have essentially sinusoidal flows. The modulation corresponds to a pulse width modulation, pulse frequency modulation or other known modulation methods. The sinusoidal currents are drawn from the supply network VN at the input of the network circuit NS.

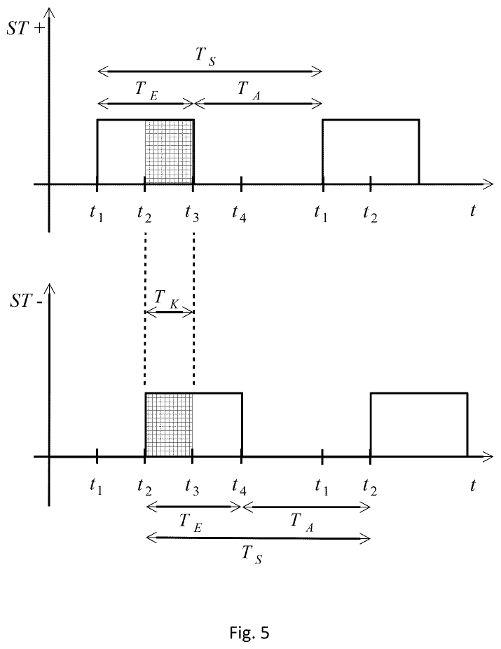

By charging the capacitor CS depending on the special type of controlling, the capacitor CS serves as an adjustable voltage source for generating a voltage difference across the coils LL1, LL2, LL3. The voltage difference across the coils LL1, LL2, LL3 can be influenced by the charge of the capacitor CS in such a way that in corresponding time periods, as shown in FIGS. 5 to 8, greater coil voltages uLL1, uLL2, uLL3 are applied to the coils LL1, LL2, LL3 than are physically provided by the supply network VN. As a result, essentially sinusoidal currents are drawn from the supply network VN in all phases L1, L2, L3, whereby the limit values of the PFC standards can be complied with in the corresponding power classes.

For this purpose, the first and second switching transistors T+, T− each receive control signals ST+, ST− from the control unit SE, whereby the first and second switching transistors T+, T− are clocked. The clocking determines different time intervals, such as a switch-on duration TE of the first switching transistor T+, a switch-on duration TE of the second switching transistor T− and a short-circuit duration TK, in which both switching transistors T+, T− are switched on or conductive at the same time. The sequence of the time intervals distinguishes between a positive controlling and a negative controlling. This special timing is described in detail below with reference to FIGS. 5 to 8. The control unit SE regulates the modulation via the length of the time intervals. At the same time, the length of the time intervals and the short-circuit duration TK are used to control the level of the intermediate circuit direct voltage UZK. During the time intervals, the capacitor CS of the midpoint network MPN is charged. Charging takes place in relation to the artificial neutral conductor provided by the coupling circuit KS.

FIG. 5 shows a flow of a first control signal ST+ for the first switching transistor T+ and a flow of a second control signal ST− for the second switching transistor T− based on the positive controlling of the first switching transistor T+ and the second switching transistor T− over time.

With positive controlling, the control inputs AN of the first and second switching transistors T+, T− are controlled by the control unit SE in such a way that the first switching transistor T+ is/becomes conductive between a first time t1 and a third time t3 for a switch-on duration TE and then the second switching transistor T− is/becomes conductive between a second time t2 and a fourth time t4 for the switch-on duration TE. Between the second time t2 and the third time t3, for a short-circuit duration TK, the first and second switching transistors T+, T− are simultaneously conductive. While the first control signal ST+ is zero, the first switching transistor T+ is non-conductive. The first switching transistor T+ is nonconductive for a switch-off duration TA between the third time t3 of a current control period TS to the first time t1 of the next control period, while the first switching transistor T+ is not controlled by the control unit SE. While the second control signal ST− is zero, the second switching transistor T− is non-conductive. The second switching transistor T− is non-conductive for the switch-off duration TA between the fourth time t4 of the current control period TS to the second time t2 of the next control period, while the second switching transistor Tis not controlled by the control unit SE.

The intermediate circuit direct voltage UZK can optionally be controlled via the duty cycle TV of switch-on duration TE to switch-off duration TA or control period TS of the first and second switching transistors T+, T− and in conjunction with the short-circuit duration TK. The switch-on duration TE of the first switching transistor T+ and the switch-on duration TE of the second switching transistor T− are selected in FIG. 5 as being of equal length. The sum of the switch-on duration TE and the switch-off duration TA results in the control period TS. However, the switch-on duration TE of the first switching transistor T+ and the switch-on duration TE of the second switching transistor T− can also be selected to be of different lengths. The switch-on duration TE can also be modulated via the control unit SE in order to have different durations in each control period TS. Thus, the equally long switch-on duration TE of the first and second switching transistors T+, T− in FIG. 5 is merely an example to illustrate the positive controlling, without the intention of limiting the positive (and negative) controlling to this example.

A reciprocal of the control period TS results in a clock frequency fs, with which the first switching transistor T+ and the second switching transistor T− are clocked by the controlling of the control unit SE. It should be noted that the clocking must take place at a sufficiently high clock frequency fs compared to the network frequency fN in order to minimize the cost of filtering the harmonics caused by the clocking.

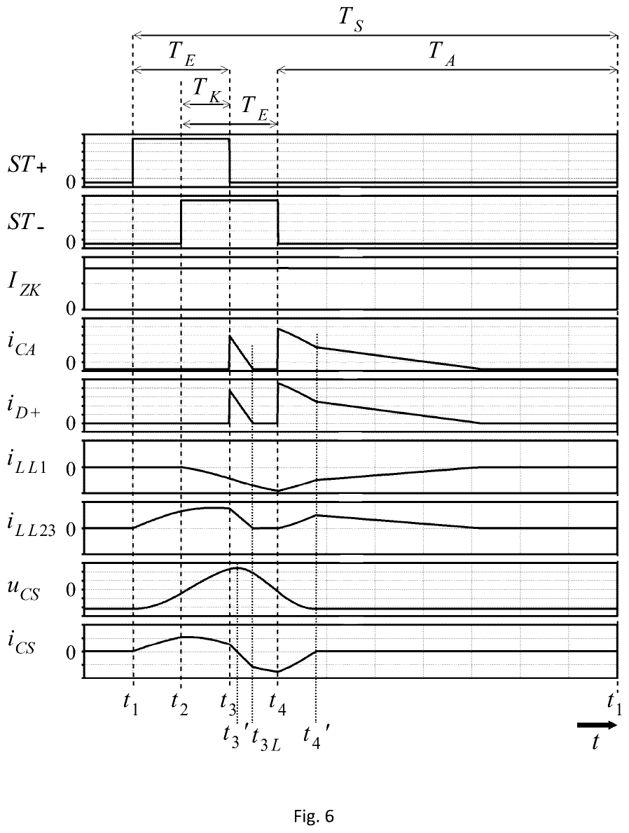

FIG. 6 shows the main characteristic curves of the positive controlling depending on the timing of the first and second switching transistors T+, T− of the network circuit NS from FIG. 4 over time. The exemplary assumptions that the string voltages u2 and u3 at phases L2 and L3 are equal in absolute value and greater than 0 volts apply, while the string voltage u1 at phase L1 is less than 0 volts. Accordingly, the coils LL2 and LL3 are connected to the first switching transistor T+ via the positive output pG of the rectifier GR. Coil LL1, on the other hand, is connected to the second switching transistor T− via the negative output nG of rectifier GR. These assumptions are exemplary and apply to the characteristic curves described below, in which the network voltages of two phases are greater than zero. The selected assumptions are not intended to limit the scope of the invention and could be made in other ways.

For better illustration, the control signals ST+, ST− are also shown in FIG. 6 in order to determine the times (t1 to t4′) for the respective time intervals. The flow of the first control signal ST+ and the second control signal ST− corresponds to that in FIG. 5 and is not repeated here.

FIG. 6 also shows a flow of the output current IZK, a flow of an output capacitor current iCA of the output capacitor CA, a flow of a diode current iD+ via the first diode D+, a flow of the coil current iLL1 via the coil LL1, a flow of the coil current iLL23, corresponding to the sum of the coil current iLL2 and iLL3, a flow of the capacitor voltage uCS and a flow of a capacitor current iCS over time. The flow of the output current IZK remains constant greater than zero over the entire control period TS.

At the first time t1, when the first switching transistor T+ becomes conductive, a positive capacitor current iCS is established at capacitor CS due to the controlled first switching transistor T+ and the upstream coils LL1, LL2, LL3. The capacitor CS is discharged to the capacitor voltage uCS=0V by the positively increasing capacitor current iCS. The coil current iLL23, as the sum of the coil currents iLL2 and iLL3 of the coils LL2 and LL3, increases positively in line with the capacitor current iCS up to the second time t2.

At the second time t2, the second switching transistor T− becomes conductive, while the first switching transistor T+ is also conductive. The second switching transistor T− is controlled as conductive by the control unit SE when a set time period has elapsed or alternatively when the capacitor voltage uCS equals zero volts. As a result, the rectifier GR is short-circuited for the short-circuit duration TK. The capacitor CS is positively charged from this second time t2, starting from the discharged state, wherein the capacitor current iCS decreases in absolute value from the second time t2. Meanwhile, the coil current iLL23 in the coils LL2 and LL3 continues to build up positively or continues to increase positively during the short-circuit duration TK. A negative current build-up begins in coil LL1 from the second time t2, so the coil current iLL1 increases in a negative direction. Between the second time t2 and the third time t3, most of the electrical energy is absorbed by the components of the network circuit LV.

At the third time t3, the first switching transistor T+, which is conducting at time t1, is switched off again by the control unit SE after the switch-on duration TE. The second switching transistor T− remains conductive until the fourth time t4. From the third time t3, the coils LL2 and LL3, in which a positive coil current iLL23 has built up during the switch-on duration TE of the first switching transistor T+, control this coil current iLL23 via rectifier diodes D3, D5 of the rectifier GR on the input side and the first and second diodes D+, Don the output side towards a load. This results in a diode current iD+ and an output capacitor current iCA, the absolute value of which decreases steadily in absolute value from the third time t3. The coil current iLL23 in the coils LL2 and LL3 also decreases again in absolute value. From the third time t3, the capacitor current iCS decreases more sharply and becomes zero amperes at time t3′. As the second switching transistor T− is still conducting, the coil current iLL23 flows via the first and second diode D+, D− and then splits into a current through the coil LL1 and a current through the capacitor CS until the capacitor current iCS reaches zero amperes.

At time t3′, the capacitor current iCS is equal to zero amperes and the maximum positive capacitor voltage uCS is reached. From time t3′, a negative capacitor current iCS is established via the capacitor CS, which increases negatively over time until time t4. The capacitor CS is continuously discharged again. From time t3′, the negative capacitor current iCS of the capacitor CS is added to the coil current iLL23, which continues to flow via the first diode D+, the load, and the second diode D−. The sum of the two currents corresponds to the coil current iLL1 of the coil LLT.

At time t3L, the coil current iLL23 of coils LL2 and LL3 is completely reduced. The coil current iLL23 corresponds to zero amperes at time t3L. Accordingly, the first and second diode D+, D− block and the diode current iD+ becomes equal to zero amperes, the output capacitor current iCA becomes negative by taking over the intermediate circuit current IZK. The entire negative capacitor current iCS of the capacitor CS continues to flow via the coil LL1, from time t3L, causing the coil current iLL1 to continue to increase negatively.

At the fourth time t4, the second switching transistor T−, which was still conducting until then, is controlled by the switching unit SE in such a way that the second switching transistor T− becomes non-conducting. From the fourth time t4, the coil LL1 continues to control the coil current iLL1 again via the first and second diode D+, D− and the load connected to the output of the network circuit NS. As a result, the diode current iD+ and the output capacitor current iCA increase immediately. From the fourth time t4, the capacitor current iCS flows via the only remaining current path in the form of the body diode contained in the first switching transistor T+ or the freewheeling diode connected in parallel to the first switching transistor T+. The capacitor current iCS decreases again in absolute value and approaches zero amperes from the fourth time t4 until time t4′. As a result, the capacitor CS is recharged to its original negative value, which prevailed at the first time t1. At the same time, a positive coil current iLL23 begins to build up again in the two coils LL2 and LL3. The diode current iD+ and the output capacitor current iCA decrease constantly until time t4′.

At time t4′, the absolute value of the coil current iLL1 of coil LL1 corresponds to the absolute value of the coil current iLL23 and therefore to the sum of the absolute values of the coil current iLL2 and the coil current iLL3. This makes the capacitor current iCS equal to zero amperes. From time t4′, no more current flows from the capacitor CS via the body diode or the freewheeling diode of the first switching transistor T+. At time t4′, the capacitor CS is fully charged to the negative initial value of the first time t1, which is available again for the next control period TS. The coils LLT, LL2, LL3 continue to control the current via the first and second diode D+, D− and the load connected to the output of the network circuit NS, whereby the remaining coil currents iLL1, iLL23 of all three coils LL1, LL2, LL3 decrease linearly with time. As the coil currents iLL1, iLL23 decrease from time t4′, the diode current iD+ and the output capacitor current iCA also decrease in absolute value. The coil currents iLL1, iLL23 become equal to OA in discontinuous conduction mode before the end of the control period TS or in boundary conduction mode at the end of the control period TS.

In boundary conduction mode, one of the coil currents iLL1, iLL2, iLL3 becomes zero exactly at the end of a control period TS. In discontinuous conduction mode, a pause is inserted between current reduction and the start of the new control period TS (the current “discontinues” or has a discontinuity). Discontinuous conduction mode and boundary conduction mode are standard when using step-up converters.

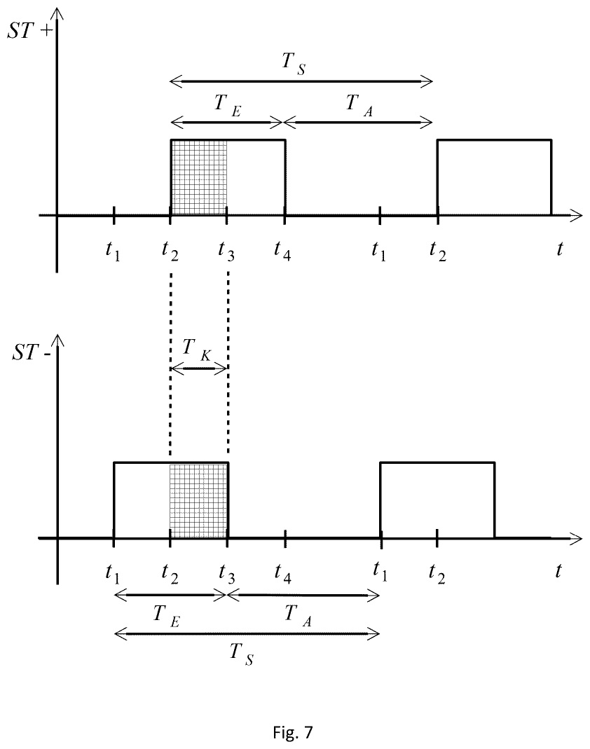

FIG. 7 shows a flow of the first control signal ST+ for the first switching transistor T+ and a flow of the second control signal ST− for the second switching transistor T− based on the negative controlling of the first switching transistor T+ and the second switching transistor T− over time. In the case of negative controlling, the switch-on duration TE, switch-off duration TA, short-circuit duration TK and switching period TS correspond to those of positive controlling, with the difference that they start and end at different times. This means that the same applies to the switch-on duration TE, switch-off duration TA, short-circuit duration TK and switching period TS as for positive controlling.

With negative controlling, the control inputs AN of the first and second switching transistors T+, T− are controlled by the control unit SE in such a way that the second switching transistor T− is/becomes conductive between the first time t1 and the third time t3 for the switch-on duration TE and then the first switching transistor T+ is/becomes conductive between the second time t2 and the fourth time t4 for the switch-on duration TE. Between the second time t2 and the third time t3, for the short-circuit duration TK, the first and second switching transistors T+, T− are simultaneously conductive. The first switching transistor T+ is non-conductive for a switch-off duration TA between the fourth time t4 of the current control period TS up to a second time t2 of the next control period, while the first switching transistor T+ is not controlled by the control unit SE. The second switching transistor T− is non-conductive for the switch-off duration TA between the third time t3 of the current control period TS up to the first time t1 of the next control period, while the second switching transistor T− is not controlled by the control unit SE.

With negative controlling, it is also important to ensure that the clock frequency fs is sufficiently high compared to the network frequency fN.

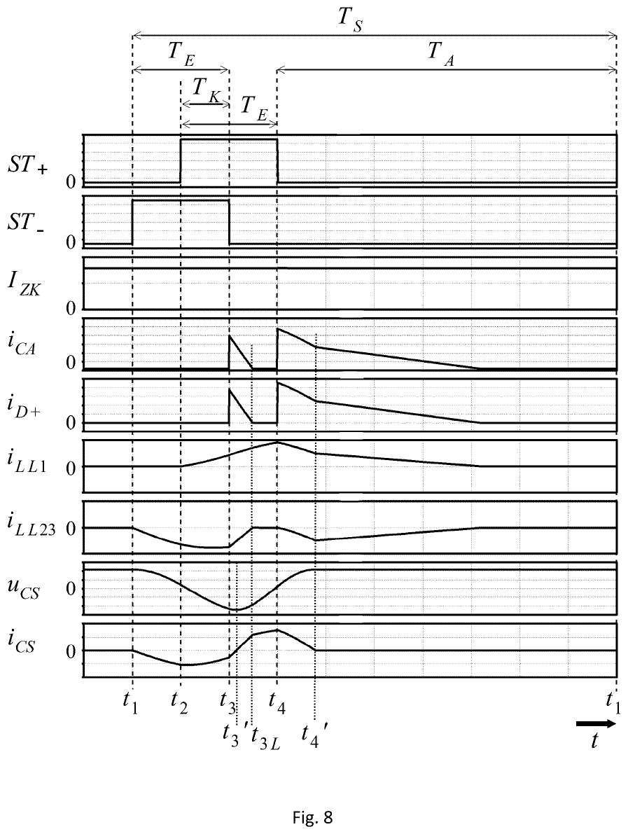

FIG. 8 shows the main characteristic curves of the positive controlling depending on the timing of the first and second switching transistors T+, T− of the network circuit NS from FIG. 4 over time. The exemplary assumptions apply that the string voltage u1 of phase L1 is greater than zero volts, while the string voltages u2 and u3 of phases L2 and L3 are of equal absolute value and less than zero volts. Accordingly, the coil LL1 is connected to the first switching transistor T+ via the positive output pG of the rectifier GR. Coils LL2 and LL3, on the other hand, are connected to the second switching transistor T− via the negative output nG of rectifier GR. These assumptions are exemplary and apply to the characteristic curves described below, in which the network voltages of two phases are less than zero. The selected assumptions are not intended to limit the scope of the invention and could be made in other ways.

For better illustration, the control signals ST+, ST− are also shown in FIG. 8 in order to determine the times (t1 to t4′) for the respective time intervals. The flow of the first control signal ST+ and the second control signal ST− corresponds to that in FIG. 7 and is not repeated here.

FIG. 8 also shows the flow of the output current IZK, the flow of the output capacitor current iCA, the flow of the diode current iD+, the flow of the coil current iLL1, the flow of the coil current iLL23, corresponding to the sum of the coil current iLL2 and iLL3, the flow of the capacitor voltage uCS and the flow of the capacitor current iCS over time. The flow of the output current IZK remains constant greater than zero over the entire control period TS.

At the first time t1, when the second switching transistor T− becomes conductive, a negative capacitor current iCS occurs at capacitor CS due to the controlled second switching transistor T− and the upstream coils LL1, LL2, LL3. The capacitor CS is discharged to the capacitor voltage uCS=0V by the negative increasing capacitor current iCS. The coil current iLL23, as the sum of the coil currents iLL2 and iLL3 of the coils LL2 and LL3, increases negatively in line with the capacitor current iCS up to the second time t2.

At the second time t2, the first switching transistor T+ becomes conductive, while the second switching transistor T− is also conductive. The first switching transistor T+ is controlled as conductive by the control unit SE when a set time period has elapsed or alternatively when the capacitor voltage uCS equals zero volts. As a result, the rectifier GR is short-circuited for the short-circuit duration TK. From this second time t2, the capacitor CS is negatively charged from the discharged state, with the capacitor current iCS decreasing in absolute value from the second time t2. Meanwhile, the coil current iLL23 in coils LL2 and LL3 continues to build up negatively. In coil LL1, a positive current build-up begins from the second time t2, so the coil current iLL1 increases in absolute value in a positive direction. Between the second time t2 and the third time t3, most of the electrical energy is absorbed by the components of the network circuit LV.

At the third time t3, the second switching transistor T−, which was conducting at the first time t1, is switched off again by the control unit SE after the switch-on duration TE. The first switching transistor T+ remains conductive until the fourth time t4. From the third time t3, the coils LL2 and LL3, in which a negative coil current iLL23 has built up during the switch-on duration TE of the second switching transistor T−, control this coil current iLL23 via rectifier diodes D4, D6 of the rectifier GR on the input side and the first and second diodes D+, D− on the output side towards a load.

The diode current iD+ and the output capacitor current iCA are set, the absolute value of which decreases steadily from the third time t3. The coil current iLL23 in the coils LL2 and LL3 also decreases again. From the third time t3, the capacitor current iCS decreases more sharply in absolute value and becomes zero amperes at time t3′. As the first switching transistor T+ is still conducting, a current through the capacitor CS is added to the coil current iLL1 flowing through the coil LL1 until the capacitor current iCS reaches zero amperes.

At time t3′, the capacitor current iCS is equal to zero amperes and the maximum negative capacitor voltage uCS is reached. From time t3′, a positive capacitor current iCS is established via the capacitor CS, which increases positively over time until time t4. The capacitor CS is discharged again. From time t3′, the positive capacitor current iCS of capacitor CS is subtracted from the coil current iLL1 of coil LL1, which continues to flow via D+, D− and the load. The difference between the two currents corresponds to the coil current iLL23 of coils LL2 and LL3.

At time t3L, the coil current iLL23 of coils LL2 and LL3 is completely reduced. The coil current iLL23 corresponds to zero amperes at time t3L. Accordingly, the first and second diode D+, D− block and the diode current iD+ becomes equal to zero amperes, the output capacitor current iCA becomes negative by taking over the intermediate circuit current IZK. The entire positive capacitor current iCS of the capacitor CS continues to flow via the coil LL1, from time t3L onwards, causing the coil current iLL1 to continue to increase positively.

At the fourth time t4, the first switching transistor T+, which was still conducting until then, is controlled by the switching unit SE in such a way that the first switching transistor T+ becomes non-conducting. From the fourth time t4, the coil LL1 controls the coil current iLL1 again via the first and second diode D+, D− and the load connected to the output of the network circuit NS. As a result, the diode current iD+ and the output capacitor current iCA increase immediately. From the fourth time t4, the capacitor current iCS flows via the only remaining current path in the form of the body diode contained in the second switching transistor T− or the freewheeling diode connected in parallel to the second switching transistor T−. The capacitor current iCS decreases again in absolute value and approaches zero amperes from the fourth time t4 until time t4′. As a result, the capacitor CS is recharged to its original positive value, as it was at the first time t1. At the same time, a negative coil current iLL23 begins to build up again in the two coils LL2 and LL3. The diode current iD+ and the output capacitor current iCA decrease constantly until time t4′.

At time t4′, the absolute value of the coil current iLL1 of coil LL1 corresponds to the absolute value of the coil current iLL23 and therefore to the sum of the absolute values of the coil current iLL2 and the coil current iLL3. This makes the capacitor current iCS equal to zero amperes. From time t4′, no more current flows from the capacitor CS via the body diode or the freewheeling diode of the second switching transistor T−. At time t4′, the capacitor CS is fully charged to the positive initial value of the first time t1, which is available again for the next control period TS. The coils LL1, LL2, LL3 continue to control the current via the first and second diode D+, D− and the load connected to the output of the network circuit NS, whereby the remaining coil currents iLL1, iLL23 of all three coils LL1, LL2, LL3 decrease linearly with time. As the coil currents iLL1, iLL23 decrease from time t4′, the diode current iD+ and the output capacitor current iCA also decrease in absolute value. The coil currents iLL1, iLL23 become equal to OA in discontinuous conduction mode before the end of the control period TS or in boundary conduction mode at the end of the control period TS.

To ensure that the network circuit NS functions as desired and can draw sinusoidal phase currents iNL1, iNL2, iNL3 from the supply network VN while complying with the limit values of the PFC standards in the corresponding power classes, not only the positive controlling or only the negative controlling takes place, but both alternate periodically during operation. The time at which positive or negative controlling is used depends on the detected and evaluated network variables in phases L1, L2 and L3.

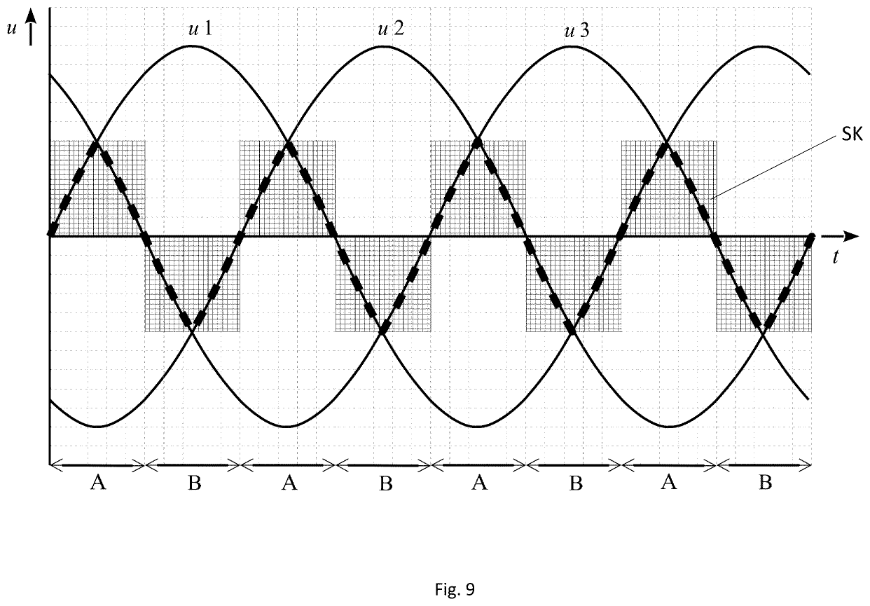

FIG. 9 shows a supply network VN as a three-phase system with string voltages u1, u2, u3 and time intervals A, B. Looking at the flow of the string voltages u1, u2, u3 of the three-phase system, there are positive time intervals A, where two string voltages are greater than zero and one phase voltage is less than zero, and negative time intervals B, where one string voltage is greater than zero and two string voltages are less than zero.

If two of the string voltages u1, u2, u3 are greater than zero, the positive controlling (see FIG. 5, 6) is used in this positive time interval A. If two of the string voltages u1, u2, u3 are less than zero, the negative controlling (see FIG. 7, 8) is used in this negative time interval B. Over time, an approximate triangular voltage curve SK (dashed line) consisting of sinusoidal sections is obtained, which is defined by the time intervals A, B and runs around the zero line.

For the time intervals A, B, i.e. the time at which the positive controlling or the negative controlling is active, the string voltages u1, u2, u3 are always in the same state, i.e. greater than zero or less than zero. For the time intervals A, B, it can therefore be defined on the basis of the symmetrical three-phase system that time interval A=time interval B.

At each zero point of the approximately triangular voltage curve SK, there is a change from the positive controlling to the negative controlling or from the negative controlling to the positive controlling. If the approximately triangular voltage curve SK runs from the negative time interval B, i.e. with a value less than zero, into the positive time interval A, i.e. with a value greater than zero, the controlling changes from a negative controlling to a positive controlling. The transition from positive/negative controlling to negative/positive controlling can, for example, take place abruptly, as shown in FIG. 9. However, the transition can also be smooth (not shown).

The duration of the time intervals A, B depends on the network frequency fN. In the European supply network with a network frequency of fN=50 Hz, a zero point occurs every 3.33 milliseconds in the three-phase system. This means that the system switches between positive and negative controlling every 3.33 milliseconds. However, the network circuit NS is not limited to the European supply network. On the contrary, the network circuit NS can be put into operation for all international network voltages and frequencies.

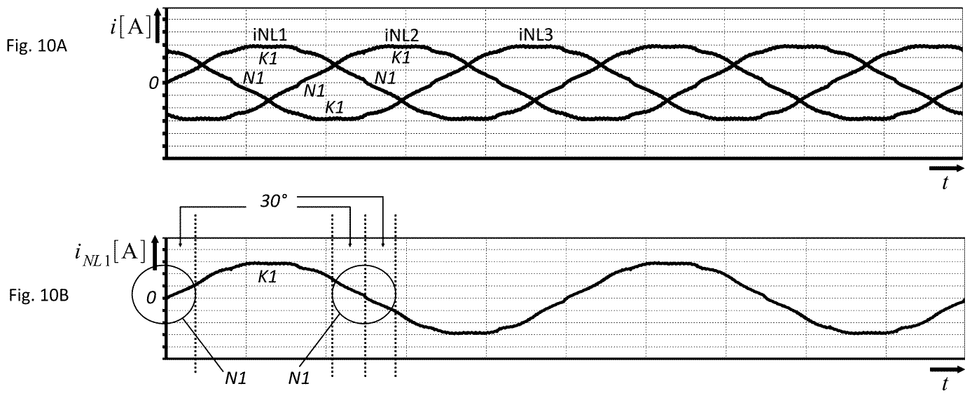

By charging the capacitor voltage uCS, a voltage difference between the string voltages u1, u2, u3 and the capacitor voltage uCS at the coils LL1, LL2, LL3 can be influenced depending on the controlling of the first and second switching transistors T+, T− by the control unit SE in such a way that greater coil voltages uLL1, uLL2, uLL3 are present at the coils LL1, LL2, LL3 than can be physically obtained from the supply network VN. In other words, the phase currents iNL1, iNL2, iNL3 are modulated by the coil voltages uLL1, uLL2, uLL3, which are influenced by the adjustable voltage applied to the capacitor CS. As shown in FIGS. 10A and 10B, this results in sinusoidal network currents iNL1, iNL2, iNL3, which are provided at the input of a rectifier in order to meet the limit values of the PFC standards in the corresponding power classes.

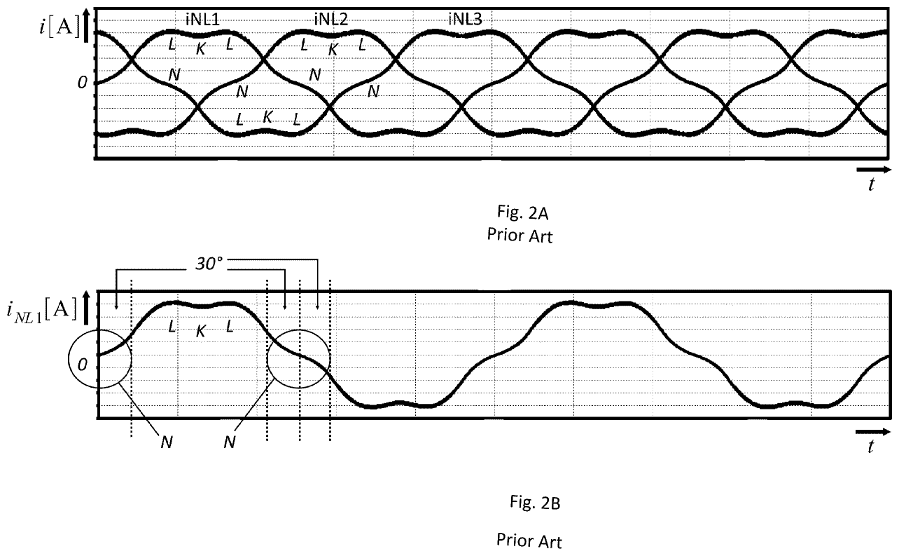

As can be seen in FIGS. 10A and 10B, the dips both in the area of the zero crossings N1 and in the area of the sine crests K1 can be corrected in comparison to the zero crossings N and the sine crests K of the flows in FIGS. 2A and 2B with the aid of the control and the capacitor CS. This results in sinusoidal phase currents iNL1, iNL2, iNL3 with minimal harmonic components, which fulfill the limit values of the PFC standards in the corresponding power classes.

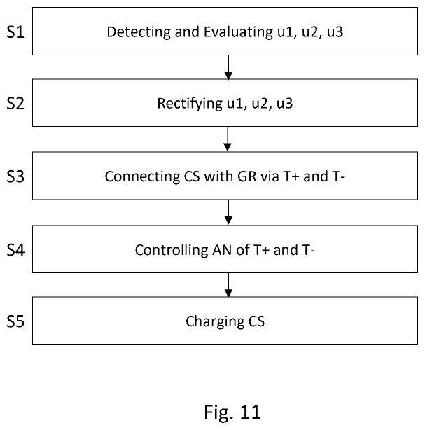

FIG. 11 shows the method in its steps according to the invention. In step S1, at least the string voltages u1, u2, u3 in the phases L1, L2, L3 are detected and evaluated by the network detection NE and the output detection AE. In step S2, the string voltages u1, u2, u3 are rectified by the rectifier GR. In step S3, the capacitor CS is electrically connected to the positive output pG or negative output nG of the rectifier GR via the first switching transistor T+ and the second switching transistor T−. In step S4, the control inputs AN of the first switching transistor T+ and the second switching transistor T− are controlled by the control unit SE depending on the time intervals A, B in such a way that only the first switching transistor T+, only the second switching transistor T−, both or neither of the first nor the second switching transistors T+, T− becomes conductive. In step S5, the capacitor CS of the midpoint network MPN is charged depending on the controlling (step S4) of the control inputs AN in such a way that voltage differences between the string voltages u1, u2, u3 and the capacitor voltage uCS, which drops across the coils LL1, LL2, LL3, lead to sinusoidal flows of the mean values of the coil currents iLL1, iLL2, iLL3. Steeper coil currents iLL1, iLL2, iLL3 are thus generated in the coils LL1, LL2, LL3 with the aid of the capacitor voltage uCS.

The method can be used for circuits of a charging station, an electric drive for machines, for power supply units and for systems for energy conversion on the supply network VN.

Reference signs

| | |
|---|---|
| A, B | time interval |
| AE | output detection |
| ON | control input |
| KS | coupling circuit |
| CA | output capacitor |
| CS | capacitor |
| CYL1, CYL2, CYL3 | capacitors |
| D1-D6 | rectifier diodes |
| D+ | first diode |
| D− | second diode |
| EMI | electromagnetic filter (filter against |
| | electromagnetic interference) |
| fN | network frequency |
| GR | rectifier |
| iNL1, iNL2, iNL3 | phase currents |
| IZK | intermediate circuit direct current |
| KS | coupling circuit |
| L1, L2, L3 | phases |
| LL1, LL2, LL3 | coils |
| MPN | midpoint network |
| NS | network circuit |
| NE | network detection |
| SE | control unit |
| SK | triangular voltage curve |
| SP | reference potential |
| T+ | first switching transistor |
| T− | second switching transistor |
| TE | switch-on duration |
| TC | short circuit duration |
| u1, u2, u3 | string voltages |
| u12, u23, u31 | conductor voltages |
| uCS | capacitor voltage |
| UZK | intermediate circuit direct voltage |
| VN | supply network |

1. A method of providing sinusoidal phase currents to a rectifier, the method comprising the steps of:
detecting and evaluating string voltages;
rectifying the string voltages;
connecting a capacitor to a positive output or negative output of a rectifier via one of a first switching transistor or a second switching transistor;
controlling control inputs of the first switching transistor and the second switching transistor by the control unit in such a way that only the first switching transistor, only the second switching transistor, both or neither of the first nor the second switching transistors becomes conductive; and
charging a capacitor voltage at a capacitor depending on controlling the control inputs such that differences between the string voltages and the capacitor voltage which drops across the coils lead to sinusoidal flows of the mean values of the coil currents, wherein
the controlling is one of a positive controlling or a negative controlling, wherein the positive controlling takes place in a positive time interval in which two of three string voltages are positive, and wherein the negative controlling takes place in a negative time interval in which two of three string voltages are negative.

2. The method according to claim 1, wherein
the controlling takes place in such a way that in the positive controlling the first switching transistor is/becomes conductive at a first time up to a third time for a switch-on duration, the second switching transistor is/becomes conductive at a second time up to a fourth time for a switch-on duration, and the first and second switching transistors are/become conductive at the second time up to the third time for a short-circuit duration.

3. The method according to claim 2, wherein
the controlling takes place in such a way that during the negative controlling the second switching transistor is/becomes conductive at a first time up to a third time for a switch-on duration, the first switching transistor is/becomes conductive at a second time up to a fourth time for a switch-on duration and during the second time up to the third time the first and second switching transistors are/become conductive for a short-circuit duration.

4. The method according to claim 2, wherein the controlling takes place in such a way that the switch-on duration of the first and second switching transistors is the same.

5. The method according to claim 2, wherein the controlling takes place in such a way that the switch-on duration of the first and second switching transistors is modulated.

6. The method according to claim 2, wherein the short-circuit duration during controlling results in a period of time in which the first switching transistor and the second switching transistor are conductive.

7. The method according to claim 1, wherein the controlling is clocked with a clock frequency higher than a network frequency.

8. The method according to claim 1, wherein charging includes one of pre-charging, charging, recharging and discharging.

9. The method according to claim 1, further comprising:
providing a reference potential for the capacitor in the midpoint network on a coupling circuit.

10. The method according to claim 1, further comprising:
detecting output variables of at least one of an intermediate circuit direct voltage, an intermediate circuit current, a positive and negative rectifier voltage, a capacitor voltage with respect to the reference potential and a capacitor current.

11. Use of the method according to claim 1 for at least one of a charging station, an electric drive for machines, a power supply unit and systems for energy conversion on the supply network.
